(19) United States
(12) Patent Application Publication
(10) Pub. No.: US 2017/0187161 A1
(43) Pub. Date: Jun. 29, 2017

(54) LOW CARRIER PHASE NOISE FIBER OSCILLATORS

(71) Applicant: IMRA America, Inc., Ann Arbor, MI (US)

(72) Inventors: Martin E. Fermann, Dexter, MI (US); Naoya Kuse, Longmont, CO (US); Kevin F. Lee, Ann Arbor, MI (US)

(21) Appl. No.: 15/460,040

(22) Filed: Mar. 15, 2017

Related U.S. Application Data
(63) Continuation of application No. PCT/US2015/050362, filed on Sep. 16, 2015.
(60) Provisional application No. 62/053,401, filed on Sep. 22, 2014.
(60) Provisional application No. 62/093,889, filed on Dec. 18, 2014.

(51) Int. Cl. H01S 3/11; H01S 3/10; H01S 3/13; H01S 3/094; H01S 3/131; H01S 3/16; H01S 3/067; H01S 3/23; H01S 3/108; H01S 3/106; H01S 3/0941

(52) U.S. Cl. CPC H01S 3/1112; H01S 3/106; H01S 3/10061; H01S 3/1305; H01S 3/094003; H01S 3/0941; H01S 3/1608; H01S 3/06758; H01S 3/2308; H01S 3/108; H01S 3/1067; H01S 3/1312; H01S 2301/02

(57) ABSTRACT

The present disclosure relates to the design of fiber frequency comb lasers with low carrier phase noise. Examples of these low carrier phase noise oscillators can be constructed from both soliton and dispersion compensated fiber lasers via the use of intra-cavity amplitude modulators such as graphene modulators. In low carrier phase noise dispersion compensated fiber frequency comb lasers, graphene and/or bulk modulators can further be used, for example, for phase locking of one comb line to an external continuous wave (cw) reference laser via high bandwidth control of the repetition rate of the comb laser via the graphene modulator. As a result a low phase noise radio frequency (RF) signal can be generated. In some implementations, a frequency comb exhibiting phase noise suppression of at least about 10 dB over a frequency range up to about 100 kHz is provided.

### CROSS-REFERENCE TO RELATED APPLICATIONS

This application is a continuation of international PCT Application No. PCT/US2015/050362, filed Sep. 16, 2015, entitled “LOW CARRIER PHASE NOISE FIBER OSCILLATORS,” which claims the benefit of priority to U.S. Patent Application No. 62/053,401, filed Sep. 22, 2014, entitled “LOW CARRIER PHASE NOISE FIBER OSCILLATORS” and U.S. Patent Application No. 62/093,889, filed Dec. 18, 2014, entitled “LOW CARRIER PHASE NOISE FIBER OSCILLATORS;” each of the foregoing is hereby incorporated by reference herein in its entirety.

### FIELD

The present disclosure relates to the construction of low carrier phase noise fiber oscillators and their applications.

### BACKGROUND

High brightness broadband optical frequency comb sources have many applications in medicine, spectroscopy, microscopy, ranging, sensing and metrology. Such sources need to be highly robust, have long term stability, and also comprise a minimal component count with a high degree of optical integration for mass market applications.

### SUMMARY

In one aspect the present disclosure features a new source for the generation of highly coherent frequency combs based on compact fiber soliton lasers.

In another embodiment passively mode locked erbium (Er) fiber lasers are implemented. The carrier envelope offset frequency of such oscillators can be conveniently stabilized to a high level of precision with an intra-cavity amplitude modulator, such as, e.g., a graphene modulator. Appropriate amplification stages can further be used to increase the output power of these sources; nonlinear frequency conversion stages such as supercontinuum generation, difference frequency generation (DFG) and optical parametric oscillators (OPO) and amplifiers (OPA) can be implemented to increase the spectral coverage or to shift the spectral output of the modelocked lasers into a spectral region of interest. For some applications, frequency shifting may, but does not need to, preserve coherence or the comb structure of the source.

The fiber comb lasers can be used in many applications, such as low phase noise radio frequency (RF) generation, RF frequency standards, radar, global positioning systems, accelerometers, gyroscopes, gravitometers, atomic interferometers as well inertial navigational systems and geodesy. Other applications of intra-cavity or graphene modulators are also possible such as low concentration gas detection.

Some of these applications may greatly benefit from the use of an amplitude or graphene modulator for repetition rate control, where the modulation bandwidth of the graphene modulator in the optical frequency domain is preferably larger than the linewidth of the free-running carrier-envelope offset frequency of the comb laser.

An amplitude or graphene modulator can also be used for locking the repetition rate of a comb system to the cavity mode spacing of an external cavity for cavity enhanced spectroscopy.

In another embodiment, a frequency comb system comprises a fiber oscillator having an intra-cavity graphene modulator and an intra-cavity bulk modulator. The frequency comb system can be configured for control of at least a carrier envelope offset frequency, f_{ceo}. The frequency comb system can provide a frequency comb exhibiting phase noise suppression of at least about 10 dB over a frequency range up to about 100 kHz.

### BRIEF DESCRIPTION OF THE DRAWINGS

FIG. 1 schematically illustrates an Er comb system according to an embodiment.

FIG. 2 schematically illustrates an RF spectrum corresponding to the locked carrier envelope offset frequency of an embodiment of an Er soliton comb laser.

FIG. 3 schematically illustrates an alternative embodiment of an Er comb system according to an embodiment.

FIG. 4 schematically illustrates the modulation range of a graphene modulator in the optical frequency domain in relation to the carrier envelope offset frequency linewidth in an example of a low carrier phase noise comb system.

FIG. 5A schematically illustrates an embodiment for locking of an Er comb laser to an optical frequency standard.

FIG. 5B schematically illustrates an embodiment for difference frequency generation (DFG) with low amplitude noise comprising a fiber amplifier and a fiber supercontinuum source.

FIG. 6 schematically illustrates an embodiment for locking of a comb laser to an optical cavity using an amplitude modulator for fast repetition rate control.

FIG. 7 schematically illustrates an embodiment for measuring broadband absorption spectra with a comb laser locked to an optical cavity, using photoacoustic detection.

### DETAILED DESCRIPTION

Broadband optical frequency comb sources based on passively modelocked lasers in conjunction with frequency broadening or supercontinuum generation in highly nonlinear fibers or waveguides have generated of lot of interest. Particularly when used in conjunction with short pulse fiber lasers, an all-fiber system construction is possible for supercontinuum generation which results in benefits such as greatly simplified manufacturing routines, low cost and high levels of thermo-mechanical stability. For actual applications in the field, all-polarization maintaining (PM) designs are highly desired. Accordingly, the present disclosure relates to the construction of low carrier phase noise fiber oscillators and their applications. The oscillators may be modelocked.

Each of the following patents and applications are hereby incorporated by reference in their entirety: U.S. Pat. No. 7,809,222 ('222), entitled “Laser based frequency standards and their application”; U.S. Pat. No. 8,599,473 ('473), entitled: “Pulsed laser sources”; U.S. Pat. No. 8,792,525 ('525), entitled ‘Compact optical frequency comb systems’; PCT Patent Publication No. WO 2015/073257 ('257), published May 21, 2015, entitled: ‘Compact fiber short pulse laser sources’. The foregoing patent references are hereby incorporated by reference herein in their entireties so as to form part of this specification. Various embodiments of the low carrier phase noise fiber oscillators disclosed herein can utilize (or be utilized by) various components or embodiments of the systems and methods disclosed in the foregoing patent references.

Conveniently, the passive modelocking process is designed to evolve from an initial Q-switching instability via the use of saturable absorbers, as for example described in U.S. Pat. No. 6,956,887 ('887) and U.S. Pat. No. 7,453,913 ('913), both entitled “Resonant Fabry-Perot semiconductor saturable absorbers and two photon absorption power limiters”. Self-starting passive mode locking can also be achieved in all polarization maintaining configurations with more complex cavity designs involving for example nonlinear amplifying loop mirrors, as discussed in '257.

Optical fiber frequency combs are conveniently constructed from such mode locked lasers by controlling both the repetition rate as well as the carrier envelope offset frequency (CEO) inside the laser resonator, as for example disclosed in U.S. Pat. No. 6,785,303 ('303) to Holzwarth et al. The repetition rate of a resonator can be modulated at MHz repetition rates using piezo-electric transducers or electro-optic transducers. The carrier envelope offset frequency is controlled via modulation of the optical pump power. A limitation with pump power control for stabilization of the carrier envelope offset frequency as described in '303 is the limited control bandwidth, particularly in Er fiber lasers, where the achievable control bandwidth is only on the order of 100 kHz. Therefore, it is generally difficult to construct high quality comb laser systems from fiber lasers with large intrinsic carrier phase noise, as large carrier phase noise typically requires large control bandwidths for effective noise suppression.

For example soliton fiber lasers generally have a large intrinsic carrier phase noise, which thus limits the utility of soliton fiber lasers in comb applications. On the other hand soliton fiber lasers are desirable for applications in the field, as they can be highly robust and highly reliable

Recently methods for rapid control of the CEO frequency were disclosed in U.S. Pat. No. 8,792,525 ('525) ‘Compact optical frequency comb systems’, to Fermann et al. via the use of a graphene modulator. U.S. Pat. No. 8,792,525 ('525) is hereby incorporated by reference in its entirety.

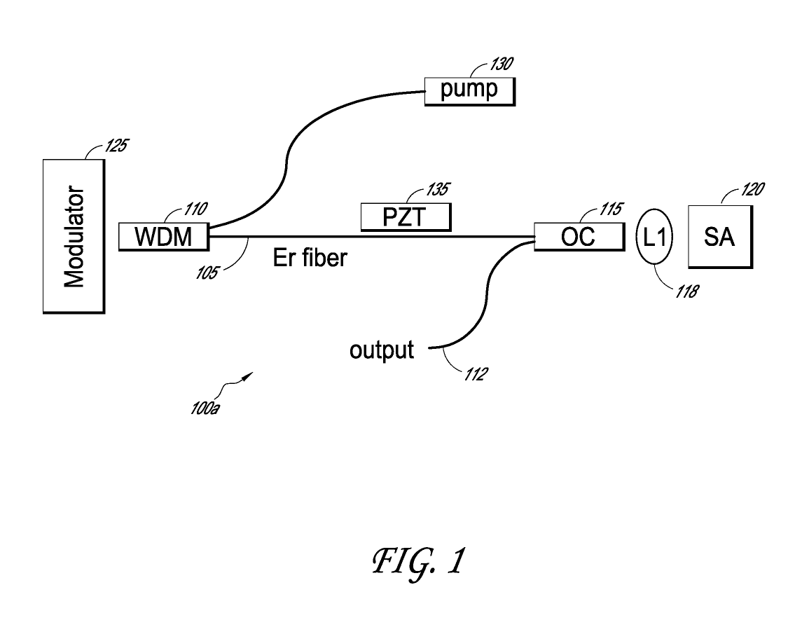

An embodiment of a highly coherent fiber frequency comb system 100a is shown in FIG. 1. The system comprises a length of polarization maintaining negative dispersion Er fiber 105 as the gain medium. In at least one preferred implementation the fiber is polarization maintaining for an increase in stability. The fiber is terminated on each side of the cavity with collimator couplers. For pump coupling, a wavelength division multiplexing coupler (WDM) 110 is used, whereas for output coupling an output coupler (OC) 115 is used to provide an output 112. Appropriate micro-optics assemblies in these two components ensure that the output from the Er fiber on both ends is collimated. In at least one embodiment the collimation function and the WDM and OC function can be performed by separate components.

A saturable absorber (SA) 120 is then used on one side of the cavity (e.g. the OC 115 side) to ensure passive modelocking. The SA 120 acts as a cavity mirror. Semiconductor saturable absorbers, but also graphene based or carbon nano-tube based saturable absorbers, can be used, just to name some examples. An optical component (e.g., lens L1 118) can be used to couple light onto the SA. The opposite side of the cavity (e.g. the WDM 110 side) is terminated with a mirror used in conjunction with an amplitude modulator 125. For example a graphene modulator deposited on a mirror structure can be used, as described in '525. The graphene modulator can also be used for repetition rate control in some configurations. The fiber laser can be pumped with a single-mode pump diode 130, for example at 976 nm. The repetition rate of the fiber laser can be conveniently controlled via one or two piezoelectric transducers (PZT) 135 attached to the intra-cavity fiber, as for example also disclosed in '525. An electro-optic modulator (not shown) can also be incorporated to allow for repetition rate control with high feedback bandwidths (>100 kHz-10 MHz). To simplify the assembly, some or all intra-cavity fibers can be selected to be polarization maintaining; the use of non-polarization maintaining components, comprising undoped fiber or Er doped fiber is also permissable in some applications.

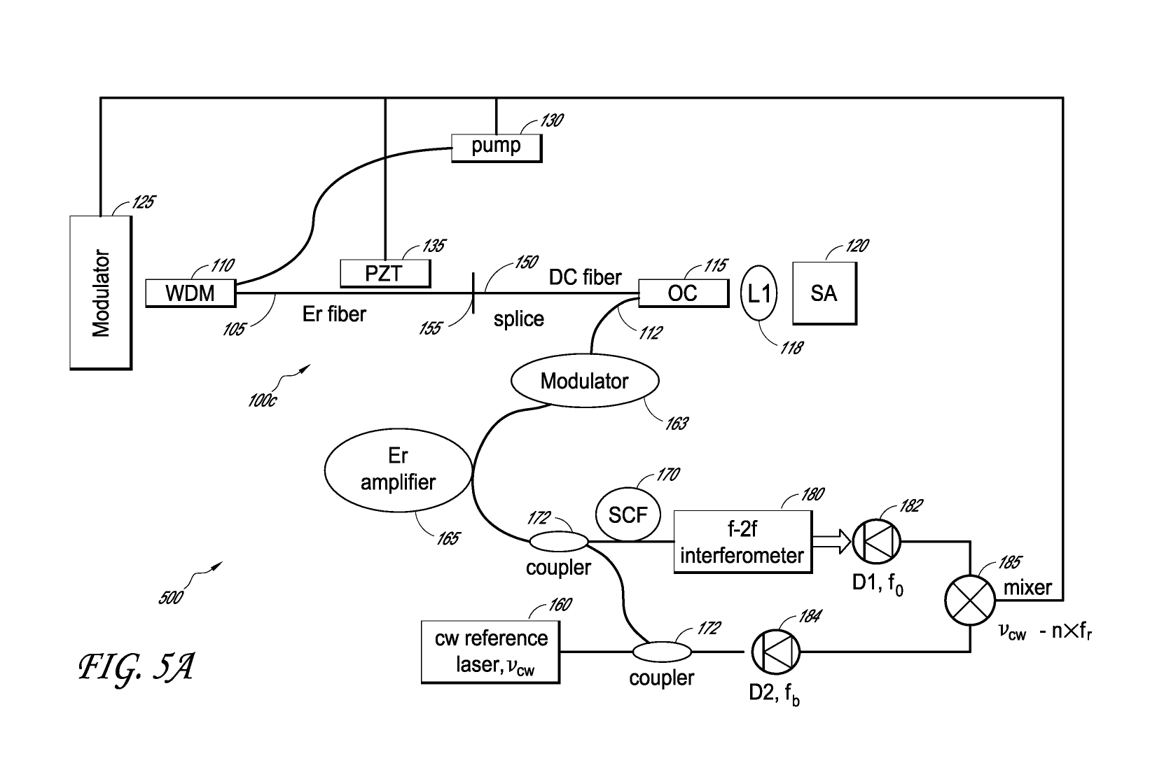

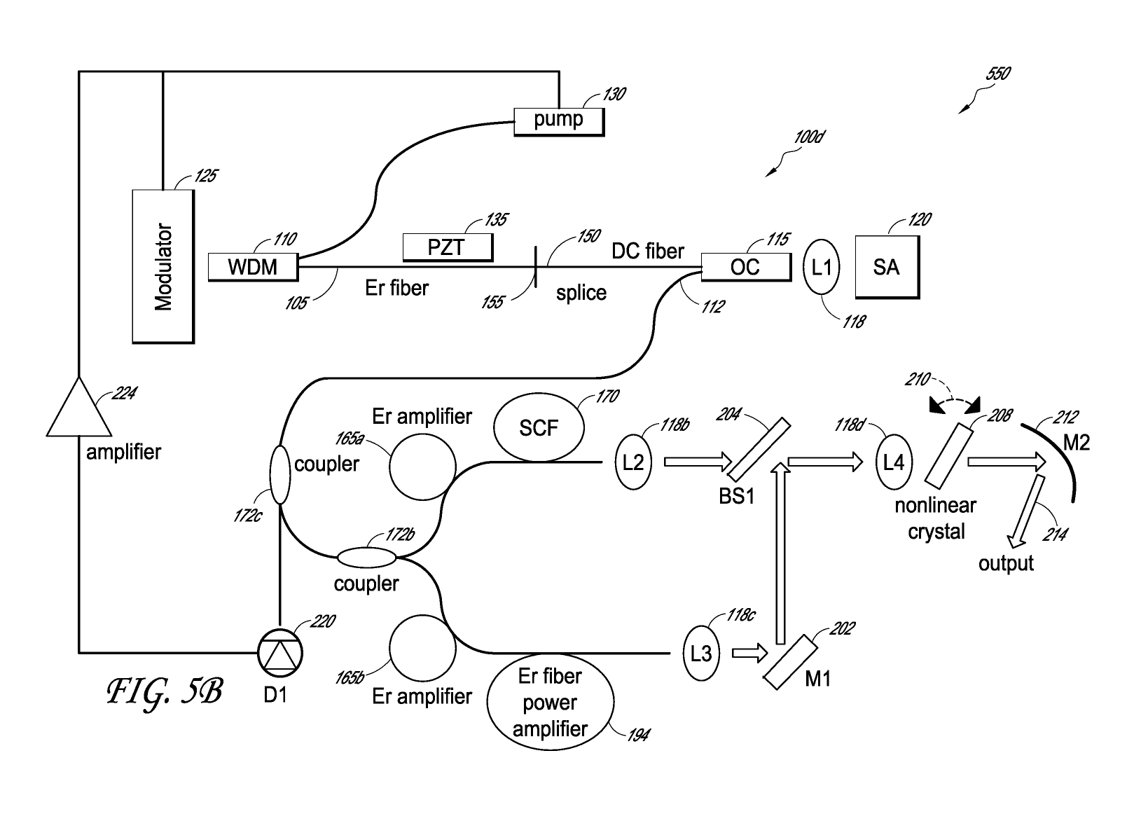

In some implementations, with typical telecom compatible fibers, a cavity operating at 100 MHz can produce 300-500 fs pulses. With an output coupler with an output coupling coefficient of about 10%, a few mW of output power can be obtained at wavelengths of 1560 nm. For convenient measurement and control of the carrier envelope offset frequency of the laser, the output can be spliced to a fiber amplifier and a supercontinuum fiber (not shown in FIG. 1), generating at least a significant fraction of an octave spanning spectrum. The carrier envelope offset frequency can then be conveniently extracted with a downstream f-2f interferometer and a detector and further illustrated below with respect to FIG. 5A. In at least one embodiment conventional feedback electronics, comprising a phase-locked loop based on a phase detector and a PID (proportional-integral-derivative) loop filter then lock the carrier envelope offset frequency to an external RF frequency. Such feedback loops can further be used for locking the repetition rate of the frequency comb laser to an external RF reference. In some embodiments one or two (or more) of the comb lines can be locked to external reference lasers.

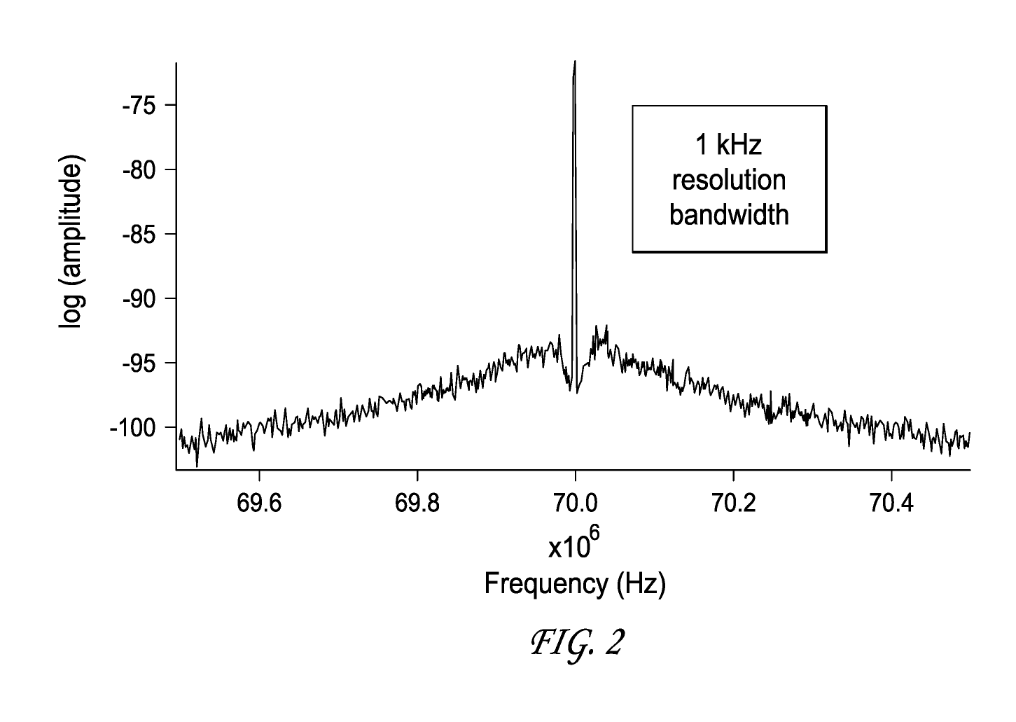

Highly stable frequency combs can be obtained even with fiber lasers with large absolute values of cavity dispersion as illustrated, for example, in FIG. 2. FIG. 2 shows an RF spectrum of a stabilized carrier envelope offset frequency, where a signal/noise ratio of about >25 dB (for a resolution bandwidth of 1 kHz) between the coherent carrier at 70 MHz and the noise background is obtained. In this example, a length L=0.9 m of intra-cavity fiber is used, giving an intra-cavity dispersion of around −42,000 fs². The absolute magnitude of dispersion is thus greater than about 45,000 fs²/L and much larger than the range of 10,000 fs²/L (or less), as, for example, described in U.S. Pat. No. 8,599,473, ('473), “Pulsed laser sources”, to Fermann et al., which is hereby incorporated by reference in its entirety. A graphene modulator advantageously allows control of the carrier envelope offset frequency with a feedback bandwidth>100 kHz, thereby providing superior performance in some applications.

The output of the frequency comb laser can further be frequency shifted into the mid infrared (IR) using, for example, DFG as disclosed in U.S. Pat. No. 8,120,778 ('778) to Fermann et al.

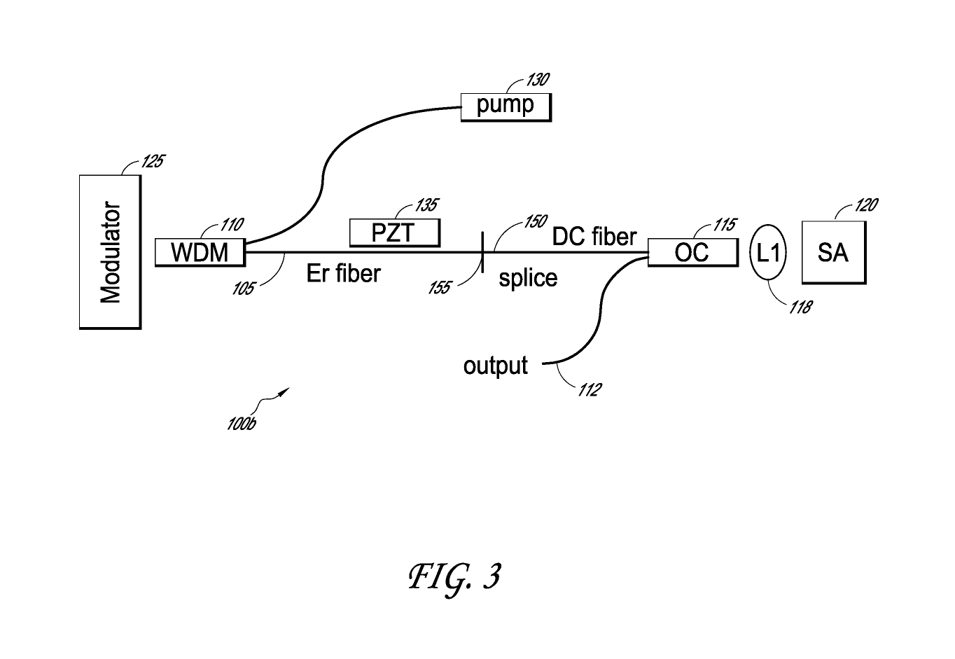

For some applications of frequency combs, the carrier envelope offset frequency noise as obtainable with a soliton laser is too high. In this case, a dispersion compensated cavity design as disclosed in and incorporated by reference U.S. Pat. No. 8,599,473 may be preferable. However, a graphene modulator can further improve the carrier phase noise of a dispersion compensated fiber comb laser. Another example of a highly coherent fiber frequency comb system 100b is shown in FIG. 3. In this example, the system 100b comprises a dispersion compensated Er fiber comb laser. The system 100b is similar to the system 100a shown in FIG. 1; however a combination of positive dispersion and negative dispersion fiber is implemented in the system 100b. In this example the two different fibers, Er fiber 105 and dispersion compensation fiber (DCF or DC fiber) 150, are connected via a splice 155. Additional lengths of Er fiber and/or DCF can be used and optically connected, for example, connected by splices. The arrangement of the Er fiber 105 and DCF 150 can be different than shown in FIG. 3, for example, the DC fiber 150 could be positioned near the WDM and the Er fiber 105 near the OC. Other combinations of positive and negative dispersion fiber may be utilized in various embodiments. In various preferred implementations at least one of the fibers is to be doped with Er (and/or other rare earth elements). The absolute magnitude of dispersion is preferably <10,000 fs²/L, as described in U.S. Pat. No. 8,599,473. The saturable absorber 120 preferably has a carrier life-time<1 ps in order to allow stable operation of a dispersion compensated fiber laser. Multiple quantum wells, bulk semiconductors, carbon nanotubes as well as graphene based saturable absorbers can also be implemented. Carrier phase locking and repetition rate locking as well as frequency shifting can be implemented as described with respect to FIG. 1.

As discussed with respect to '257, saturable absorber free passively mode locked fiber lasers can also be combined with graphene modulators to allow for high bandwidth carrier envelope offset frequency control. Such designs are not further discussed here (see, e.g., '257). In addition to using two fibers of different dispersion for dispersion compensation, a fiber grating, bulk gratings or prisms can be used for dispersion compensation. Moreover, a graphene modulator can be combined with a saturable absorber as disclosed in '525 for a more compact cavity assembly. Such designs are also not further discussed here (see, e.g., '525). Typically such fiber frequency combs can be constructed with repetition rates in the range from 10 MHz-10 GHz.

For many frequency comb applications, the locking of the two degrees of freedom of the frequency comb (repetition rate fᵣ and carrier envelope offset frequency f_{ceo}) is not required. Rather it is sufficient to lock only one comb mode to an external single frequency reference laser or to lock the one comb mode to a single frequency reference laser which is in turn locked to a gas reference cell, an ultra-stable cavity (e.g., high finesse cavity) or an optical atomic clock.

Locking of a frequency comb mode to an external reference laser can be conveniently performed by control of at least the repetition rate of the laser. Such schemes were for example disclosed in U.S. Pat. No. 7,809,222, ('222), “Laser based frequency standards and their application”, to Hartl et al. and '525 (see, e.g., at least col. 3, lines 17-20; col. 3, lines 31-35; col. 6, lines 31-34 and col. 10, line 51-53). Conveniently, a graphene modulator can be used for repetition rate control. The contents of U.S. Pat. No. 7,809,222 are hereby incorporated by reference in their entirety.

Important applications for such ‘singly’ locked frequency combs include, but are not limited to, low phase noise RF generation and transfer of optical timing and frequency standards down optical fiber transmission lines.

To reduce noise in RF generation, the carrier envelope offset frequency can be further electronically eliminated from such locking schemes, as for example described in W. Zhang, et al. IEEE Trans UFFC 58, 900 (2011). The graphene modulator can then allow for repetition rate modulation at bandwidths>100 kHz. Repetition rate modulation bandwidths>1 MHz and higher are also possible. The RF frequency modulation range, Δf_{RF}, at modulation frequencies of about 1 MHz can be of the order of a few Hz in the RF domain, e.g.: near to or greater than about 1 Hz. For Er fiber lasers operating at a repetition rate of 100 MHz, a modulation range in the RF domain is magnified in the optical frequency domain by a factor of about 2×10⁶. Hence graphene modulators can be used for modulation of an optical comb line in the optical frequency domain with a frequency modulation range Δfₒₚₜ of a few MHz, and at modulation frequencies also in the MHz range, where Δfₒₚₜ≈2×10⁶×Δf_{R}.

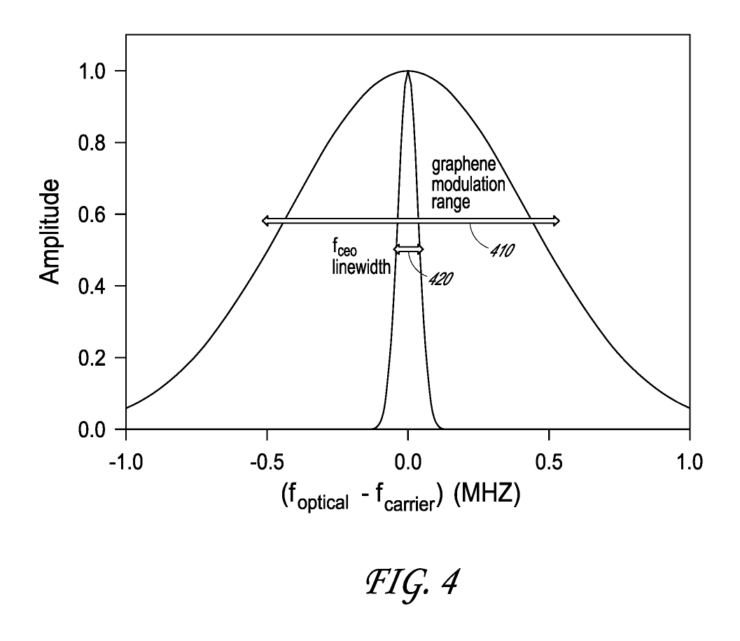

An example of achievable modulation ranges is further illustrated with respect to FIG. 4. Here the graphene modulation range Δfₒₚₜ in the optical frequency domain (shown by arrow 410 and about 1 MHz in this example) with respect to the optical carrier frequency is plotted. In this particular example the optical carrier frequency (typically in the range of 200 THz) is set as the origin for the horizontal axis. For comparison FIG. 4 also shows the typical carrier envelope offset frequency linewidth Δf_{ceo} of a low carrier phase noise oscillator (shown by arrow 420). For this example Δf_{ceo}≈100 kHz. As further discussed below, it may be advantageous if the modulation range, Δfₒₚₜ (e.g., the graphene modulation range) 410 is larger than the carrier envelope offset frequency linewidth, Δf_{ceo}, 420 as illustrated in FIG. 4.

The use of graphene modulators provides some practical benefits for rapid modulation of frequency comb lines in the optical domain. As one comparative example consider electro-optic modulators (EOMs), as shown in FIG. 3 of D. D. Hudson et al., ‘Mode-locked fiber laser frequency-controlled with an intracavity electro-optic modulator’, OPTICS LETTERS, Vol. 30, pp. 2948-2950 (2005). As shown by D. D. Hudson, for a typical fiber laser operating near a repetition rate of 100 MHz, a maximum DC response in the optical frequency domain is about 10 MHz (Hudson FIG. 3a) with an applied voltage of 500 V, whereas the EOM transfer function rolls off by −3 dB at a modulation frequency of only 230 kHz. One of the reasons for the roll off is piezo-electric resonances in the EOM which limit its performance at high modulation frequencies. In addition, the high drive voltage requirements for the EOM, relatively large form factor, and dispersion greatly limits the integration potential of EOMs into frequency combs. Graphene based modulators do not require high drive voltages and exhibit a transfer function with −3 dB roll off at frequencies>300 kHz, even roll off at frequencies>1 MHz is possible.

The utilization of graphene modulators for repetition rate control is particularly favorable when the achievable modulation range, Δfₒₚₜ, of a comb line in the optical domain is larger than the free running carrier envelope offset frequency linewidth, Δf_{ceo}, at modulation frequencies which are larger than the carrier phase modulation bandwidth obtainable with pump current modulation. In particular, Δfₒₚₜ>Δf_{ceo} may be advantageous in some implementations. Since typical Er fiber lasers allow for carrier phase modulation bandwidths of about 100 kHz (via pump current modulation), the achievable modulation range of a comb line in the optical domain at modulation frequencies≈100 kHz (achievable with a graphene modulator) is preferably larger than the free running carrier envelope offset frequency linewidth. In various implementations beneficial results may be obtainable with Δfₒₚₜ>(Δf_{ceo}/10) or Δfₒₚₜ>(Δf_{ceo}/100). In other implementations, the system may be configured such that Δfₒₚₜ>(Δf_{ceo}/X), where X=1, 2, 5, 10, 20, 30, 40, 50, 75, 100, or more.

In at least one embodiment the above condition is fulfilled with dispersion compensated Er fiber lasers as described with respect to the system 100b shown in FIG. 3, where the free running carrier envelope offset frequency linewidth can be smaller than 300 kHz, whereas the achievable modulation range of a comb line in the optical domain at modulation frequencies>100 kHz achievable with a graphene modulator can be in the MHz range. FIG. 4 further illustrates an example when this condition is fulfilled. By way of example the free-running carrier-envelope offset frequency linewidth can be measured by weakly locking the carrier-envelope offset frequency to an external RF frequency and measuring the carrier-envelope offset frequency bandwidth across the 3 dB point using an RF signal analyzer.

In practice in some applications, the graphene modulator is used for repetition rate control at only relatively ‘high’ modulation rates, whereas conventional devices such as piezo-electric transducers (PZTs) or pump current modulation can be used for repetition rate control at ‘low’ modulation rates. The separation between high and low frequencies depends on the specifics of the laser design, and in some implementations a boundary between low and high may be in the range from about 20 kHz to about 200 kHz range.

An embodiment of a graphene modulator as used for phase locking to an external continuous wave (cw) reference laser 160 is further shown in the system 500 illustrated in FIG. 5A. The cw reference laser 160 provides an optical reference frequency v_{cw}. The Er comb laser 100c preferably comprises a dispersion-compensated design as discussed with respect to the laser 100b illustrated in FIG. 3 and produces pulses at a repetition frequency fᵣ. The Er comb laser output 112 is further amplified in an Er amplifier 165 and a broadband continuum is generated with a supercontinuum fiber (SCF) 170. Appropriate couplers 172 split out a part of the output of the Er amplifier 165 to interfere with the cw reference laser 160.

In the example shown in FIG. 5A, the carrier envelope offset frequency f₀ of the comb laser is measured with an f-2f interferometer 180 and detector D1 182. The RF beat frequency f_{b} between the cw laser 160 and an nth comb line of the frequency comb laser is measured by detector D2 184. The output of detectors D1 and D2 is then electronically mixed via the shown mixer 185, which generates an RF frequency v_{cw}−n×fᵣ. The generated RF frequency is then phase locked to an external RF frequency reference relying on feedback control of the graphene modulator, the comb pump laser as well as one or several PZT controllers, where the graphene modulator is used for the highest feedback bandwidth. Additionally, the PZT controllers are implemented for lower feedback bandwidths. In FIG. 5A thin black lines indicate electrical connections between the various components mentioned above. The whole system is preferably also thermally and acoustically isolated for an optimum in stability. In at least one embodiment an electro-optic or acousto-optic modulator 163 can also be incorporated into such comb systems for further frequency control.

To generate a low phase noise RF signal, a fraction of the output of the Er comb laser can be directed to one or more Er amplifiers (not shown) that are in addition to the Er amplifier 165 shown in FIG. 5A and the Er amplifier(s) output can be directed to a semiconductor diode for optical to RF conversion. RF frequencies higher than the repetition rate of the Er comb laser can be generated by using additional interleaving stages or filter cavities up-stream or down-stream of the one or more additional Er amplifiers to generate pulses at repetition frequencies fₓ at fractional multiples of the repetition rate of the Er comb laser fᵣ, where fₓ=(n/m)fᵣ. Rather than one or more additional Er amplifiers, an additional coupler can be used downstream of the Er amplifier 165 shown in FIG. 5A, for the same purpose.

To generate a specific comb repetition rate or a tunable repetition rate, appropriate fiber stretching stages or optical delay lines can also be incorporated into the Er comb laser. Optical materials with a voltage dependent, temperature dependent or pressure dependent refractive index can also be incorporated into the comb cavity for adjustments of the repetition rate of the comb laser. Several such options are discussed in '473.

Instead of a graphene modulator, any type of intra-cavity amplitude modulator can be used. Also, instead of an Er comb laser, any other fiber comb laser can be used for locking to a cw reference laser or for RF generation, such as for example rare earth fibers (e.g., Yb, Nd, Tm, Pr, Ho fibers) or fibers co-doped with more than one rare-earth. The fiber comb laser can include multiple fibers with each fiber having different dopant(s) relative to at least one other fiber.

Since many applications of frequency combs are susceptible to amplitude noise, a feedback circuit can further be incorporated acting on the pump diode current to minimize the amplitude noise of the comb source. Such amplitude noise reduction is particularly beneficial in low phase noise RF generation or frequency shifting applications via DFG, OPOs or OPAs. Additionally or alternatively, a second graphene modulator can be incorporated into a comb laser for amplitude noise suppression at high feedback bandwidths. Such schemes were already discussed in '525 and are not further described here. To enable the incorporation of two graphene modulators, one of the modulators is preferably integrated with a saturable absorber.

Other schemes for amplitude noise suppression via appropriate feedback circuits can also be implemented. For example, an amplitude modulator such as an electro-optic modulator (EOM), acousto-optic modulator (AOM), or waveguide modulator can be inserted between the oscillator 100c and the amplifier 165 shown in FIG. 5A for amplitude noise control. The required error signal for feedback control can then be derived by, for example, diverting a small fraction of the amplified signal to a detector. The detected signal is then amplified via an amplifier and fed back to the voltage control input of the amplitude modulator via a servo loop. The intensity noise reduction servo can be based on a single proportional-integral stage and can also include phase advance circuitry to counteract amplitude roll-off and phase lag introduced from the limited amplitude noise transfer function between amplifier output and amplitude modulator loss. In principle to improve or optimize the performance of any noise reducing circuitry, the error signal can be derived at any position downstream of the oscillator output 112. In some configurations, a small fraction of the output after frequency conversion in a supercontinuum fiber (e.g.: the SCF 170 in FIG. 5A) can also be used for feedback control to reduce the amplitude noise in the supercontinuum output.

Further, in some implementations, a low noise, polarization maintaining (PM) Erbium fiber frequency comb laser may be provided. In FIG. 5A, the modulator 125 may comprise a graphene based EOM arranged in the oscillator cavity in combination with an additional intra-cavity modulator, for example bulk EOM, AOM, or waveguide modulator for a low noise configuration. The combination of the graphene EOM and an additional intra-cavity modulator may be utilized to phase lock the carrier envelope offset frequency, f_{ceo}, and an optical beat signal, f_{beat}, between one of the comb teeth and an optical reference. The graphene modulator may be configured as a cavity end mirror. In some embodiments the modulator 125 may be integrated with a semiconductor saturable absorber (SESAM) for mode locking.

As discussed above, in some implementations an amplitude modulator may be disposed external to the oscillator. In some arrangements a waveguide EOM, for example a JDS Uniphase Corporation (Milpitas, Calif.) JDSU OC-192 modulator or similar device, may be arranged outside the cavity to provide additional noise suppression in a compact arrangement. For example, referring again to FIG. 5A, a waveguide EOM may be disposed between the oscillator 100c and the downstream fiber amplifier(s) (e.g.: Er amplifier 165 or additional Er fiber amplifier(s)) or between the oscillator 100c and a downstream supercontinuum generator arranged with an f-2f interferometer (e.g.: SCF 170, f-2f interferometer 180).

By way of example, in one implementation it was determined that the phase noise of both f_{ceo} and f_{beat} was about 2-3 times lower than previous developed systems, including non PM Er combs. In some embodiments at least about 10 dB, 15 dB, or 20 dB suppression may be obtained over a frequency range, for example a range from about a few kHz to 100 kHz. Further, it is expected the low noise frequency comb implementation can be implemented at other wavelengths, for example, in Yb based systems at about 1 μm, Tm based systems at about 2 μm, and/or in mid-IR generation systems via DFG or OPA.

Amplitude noise suppression schemes are particularly useful in frequency shifting schemes involving DFG or OPA, for example in applications for mid-IR imaging in the spectral range from 2-20 μm. For these applications, preservation of the comb structure in the frequency shifting schemes may not be required. However, amplitude noise reduction of the mode locked laser sources can greatly reduce the amplitude noise of the mid-IR output which is beneficial for spectral analysis.

To enable frequency shifting via DFG, a laser system 550 as shown in FIG. 5B may be used. The system 550 includes an oscillator 100d. The oscillator 100d can comprise any of the oscillators 100a, 100b, 100c described with respect to FIGS. 1, 3, and 5A, though any other mode locked oscillator can also be implemented in other embodiments. In the following embodiments, an Er oscillator and Er amplifiers are used, though other rare-earth doped fiber oscillators or amplifiers can be implemented. The output of the oscillator 100d can be split into two parts via a fiber coupler 172b, where the first part comprises a downstream first Er amplifier 165a and a supercontinuum fiber (SCF) 170 for frequency shifting, and the second part comprises a second Er amplifier 165b and a high power amplifier 194 (e.g., an Er fiber power amplifier). Optical isolators and filters can further be inserted between various amplifier stages and are not further shown here.

Also, bulk or fiber compressor elements can further be used downstream of the Er power amplifier 194 to decrease the pulse width at the output from the Er power amplifier. Such bulk compressor elements can, for example, comprise bulk glass, prisms, chirped mirrors, volume Bragg gratings, or diffraction gratings and are not separately shown in FIG. 5B. Fiber compressor elements can, for example, comprise certain lengths of fiber or fiber Bragg gratings. Nonlinear compressor elements such as a length of fiber or a combination of fiber and bulk compressor elements can also be used. Such linear or nonlinear compressor elements are not separately shown in FIG. 5B.

Dispersive elements such as lengths of fiber or fiber or bulk Bragg gratings can be used upstream of the Er power amplifier 194 to temporally stretch the pulses in the Er power amplifier and to reduce the nonlinearity within the Er power amplifier. Such stretcher components are also not separately shown.

As yet another alternative, Tm, Ho, or Tm:Ho amplifiers can be used to amplify the output of the supercontinuum fiber 170 in the 1.7-2.3 μm range. Both symmetric as well as asymmetric supercontinuum generation can be used. Asymmetric supercontinuum generation mainly red-shifts the output of the Er amplifier via Raman-soliton generation. A combination of a first Er amplifier, a length of Raman shifting fiber, a length of Tm amplifier fiber, and another length of Raman shifting fiber can be particularly advantageous to red-shift and amplify the output of the first amplifier fiber 165a. With such a configuration, a wavelength tunable Raman soliton output in the range from 1.7-2.3 μm can be obtained. In another embodiment, the supercontinuum output can be generated by directing a small fraction of the power amplifier 194 output to a supercontinuum fiber, which reduces the need for two separate amplifier arms in DFG or OPA. Such an implementation is not separately shown in FIG. 5B.

The outputs of the SCF 170 and the Er power amplifier 194 can be collimated via lenses L2 118b and L3 118c and directed via mirror M1 202 and beamsplitter BS1 204 and focusing lens L4 118d to a nonlinear crystal 208, which is preferably mounted on a rotation stage in order to allow a change in phase-matching angle, as indicated by the dashed line 210. Additional mirrors and translation stages for group delay adjustment between the SCF 170 output and the Er power amplifier 194 output can also be inserted and are not separately shown in FIG. 5B.

The nonlinear crystal 208 produces DFG between the SCF output and the Er fiber power amplifier output, where the DFG output 214 is directed out of the system via a parabolic mirror M2 212. Instead of lenses, mirrors or parabolic mirrors can further be used in any part of the system in order to reduce or avoid aberrations arising from chromatic dispersion.

In the case of an Er system, DFG or OPA between the amplified, high power amplifier 194 part and the supercontinuum fiber 170 part can produce an output tunable between about 5-15 am using for example GaSe as the DFG crystal, where wavelength tuning includes (in some implementations) a combination of control of pulse power injected into the supercontinuum fiber, crystal orientation, and adjustment of group delay between the two amplifier paths. In some implementations, an output tunable between about 3-15 am can be obtained. Instead of, for example, GaSe as the DFG crystal, periodically poled crystals such as OPGaAs, OPGaP or PPLN (e.g., optically patterned GaAs, optically patterned GaP or periodically poled Lithium Niobate), just to name a few examples, can also be used for DFG. When using periodically poled crystals for DFG, rather than angle tuning it can be advantageous to select appropriate poling periods for wavelength tuning. This can be accomplished via the use of crystals with different poling periods or fan-out like variation of poling periods. Mounting the crystals on a linear translation stage allows for appropriate selection of a poling period for wavelength tuning.

In some implementations, noise reduction can be obtained by using feedback to at least the oscillator pump current and/or to the pump currents for at least one of the amplifiers. In at least one embodiment, noise reduction can be obtained with the use an intra-cavity or extra-cavity amplitude modulator or graphene modulator for feedback. An example of a possible scheme for amplitude or intensity noise reduction is shown in FIG. 5B. In this example, a small fraction of the output 212 of the oscillator 100d is directed via a coupler 172c to detector D1 220, the output of the detector D1 is then amplified via an amplifier 224 and fed back to the pump current of the oscillator pump diode 130 or an intra-cavity amplitude modulator 125 via a servo loop. An implementation with an extra-cavity modulator is not separately shown in FIG. 5B. The intensity noise reduction servo can be based on a single proportional-integral stage and can also include phase advance circuitry to counteract amplitude roll-off and phase lag introduced from the limited amplitude noise transfer function between oscillator output and pump current or amplitude modulator loss.

A graphene modulator in a laser oscillator can also provide a high frequency, for example 2 MHz, modulation to the output of the laser by applying an oscillating voltage to the graphene modulator. This adds side bands to the comb lines and allows graphene to serve as the sideband generator in the Pound-Drever-Hall (PDH) cavity locking method. In the PDH method, an optical enhancement cavity and laser are locked together, matching the laser frequencies to the cavity modes, so laser light is efficiently coupled into the cavity, through the high reflectivity cavity mirrors. Some light that is reflected from the second mirror, and light that is reflected from the first mirror is monitored by a photodetector. By modulating the input light, the reflected light is modulated as well, in a way that carries information about the relative matching of the laser and cavity modes. The photodetector signal can be converted by simple radio frequency filtering and mixing into an error signal for feedback for locking the laser and cavity. The same graphene component can serve as part of the frequency comb control, such as described above, as well as adding the modulation needed for PDH locking, removing any need for an additional component, such as an electro-optic modulator, for generating sidebands. To perform both functions, the driving signal for the frequency comb control, and the driving signal for the modulation can be combined electronically by a simple circuit 285, and the graphene modulator driven by the combined signal. In another implementation, the graphene modulator can be used only for generation of the modulation signal required for Pound-Drever-Hall (PDH) locking and feedback to the oscillator pump power can be used for control of the carrier envelope offset frequency of the laser.

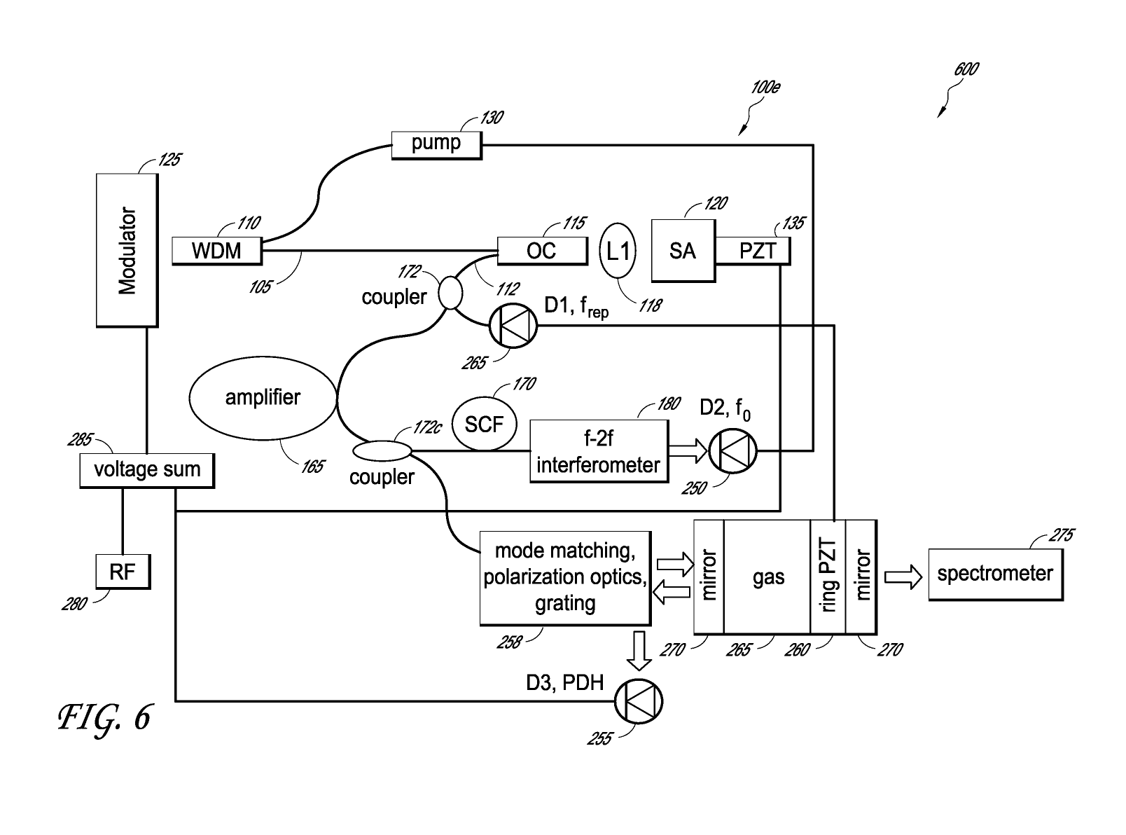

In the example system 600 shown in FIG. 6, the laser and cavity can be locked together by: stabilizing the carrier envelope offset frequency to a desirable value by controlling the oscillator pumping (e.g., via detector D2 250); locking the repetition rate to the cavity by the PDH method (e.g., via detector D3 255), using piezoelectric transducer(s) (PZT) 135 to control the laser cavity length as a medium speed control and an amplitude modulator (e.g., graphene) as the fast control and sideband generator; and stabilizing the cavity length with a ring-shaped piezoelectric transducer (ring PZT) 260, using the difference of the repetition rate from the desired value as the feedback signal (e.g., via detector D1 265). Different combinations of actuators and feedback can be chosen as needed. For example, graphene can be used to lock the carrier envelope offset frequency, while the piezoelectric transducer controls the repetition rate. The oscillator 100e can be any of the oscillators 100a, 100b, 100c, 100d described herein or any other moe-locked oscillator can be used.

Another alternative is to use the graphene modulator for generating the modulation signal used for the PDH lock, to use pump current modulation for carrier envelope offset frequency control of the laser, and to stabilize the repetition rate of the laser by locking the repetition rate to an external RF reference 280. The output from the PDH lock can then be used for locking the laser cavity length to the external cavity, where a fast control loop applied to a piezoelectric transducer located within the laser cavity can be used for fast repetition rate control, and a slow control loop can be used to control the external cavity length via another piezoelectric transducer attached to one of the mirrors of the external cavity.

A locked, high finesse cavity 265 (between two mirrors 270 shown in FIG. 6) is useful for applications such as low concentration gas detection. In the implementation shown in FIG. 6, light can be directed from the coupler 172b through mode matching or polarization optics or a grating 258 toward gas in a high finesse cavity 265. Light in the high finesse cavity 265 can interact with the gas in the cavity for a much longer time than, for example, a single pass through a gas cell, improving sensitivity. The light transmitted through the high finesse cavity can be measured by a conventional spectrometer 275, such as a Fourier transform spectrometer.

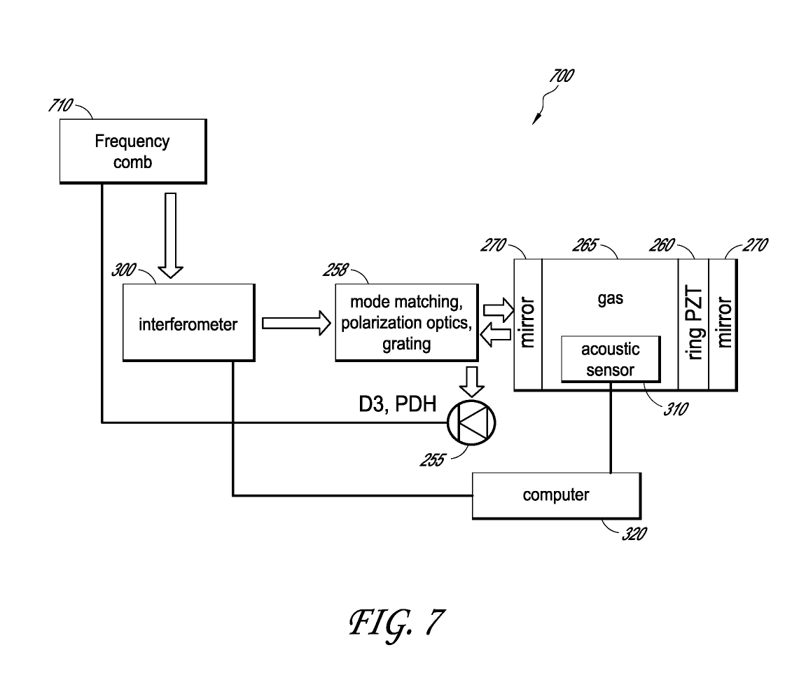

In a related embodiment shown in FIG. 7, a system 700 is used to measure the spectrum from gas in the cavity 265 is measured by photoacoustic spectroscopy. Light can come from any of the frequency combs 710 described herein or from any other frequency comb. The light intensity within the optical enhancement cavity 265 is many times stronger at the focus than if the light was simply focused without a cavity. Since the photoacoustic signal is proportional to intensity, the sensitivity of a cavity-enhanced photoacoustic measurement can be much higher than a conventional photoacoustic system. In photoacoustic spectroscopy, light modulated at acoustic frequencies excites the sample, resulting in acoustic waves that can be detected using a photoacoustic sensor 310, for example, capacitor microphones, electret microphones, piezoelectric sensors, and optical cantilevers. For broadband measurements, the light modulation can be applied by the Fourier method of passing the input beam from the comb 710 through an interferometer 300 with a variable path delay, to generate pulse pairs with variable time delay between them. As the interferometer delay is scanned, wavelengths in the combined beam will have amplitude modulations at different acoustic frequencies. The wavelengths that interact with the sample will generate acoustic waves at their characteristic frequency that are detected by the photoacoustic sensor 310. The photoacoustic signal (combined with the interferometer path delay, which is usually measured with an optical reference beam), can then be Fourier transformed (e.g., via computer 320) to reveal the absorption spectrum of the sample.

Additional arrangements for frequency shifting such as OPOs, DFG, optical parametric amplifiers (OPA) can be implemented between the output of the fiber laser and the input of the cavity, where the cavity transmission spectrum preferably overlaps with the spectrum of the frequency shifted source. In one implementation, a system 550 as shown in FIG. 5B can be used upstream of the cavity. Amplitude noise reduction circuitry may or may not be included. Additional electo-optic or acousto-optic modulators can further be implemented for intra-cavity or extra-cavity control of the carrier envelope offset frequency or the repetition rate of the comb source 710 as well as the amplitude noise.

The following patents, published patent applications, and non-patent publications are pertinent to the present disclosure:
U.S. Pat. No. 6,785,303 ('303), entitled: “Generation of stabilized, ultra-short light pulses and the use thereof for synthesizing optical frequencies”;
U.S. Pat. No. 6,956,887 ('887) and U.S. Pat. No. 7,453,913 ('913), entitled: “Resonant Fabry-Perot semiconductor saturable absorbers and two photon absorption power limiters”;
U.S. Pat. No. 7,809,222 ('222), entitled “Laser based frequency standards and their application”;
U.S. Pat. No. 8,599,473 ('473), entitled: “Pulsed laser sources”;
U.S. Pat. No. 8,792,525 ('525), entitled: ‘Compact optical frequency comb systems’;
PCT Patent Publication No. WO 2015/073257 ('257), published May 21, 2015, entitled: ‘Compact fiber short pulse laser sources’;
C. Haisch et al., “Photoacoustic spectroscopy for analytic measurements”, Meas. Sci. Technol. 23, 012001 (2012);
I. Hartl, L. Dong and M. E. Fermann, T. R. Schibli, A. Onae, F.-L. Hong, H. Inaba, K. Minoshima, and H. Matsumoto, ‘Fiber Based Frequency Comb Lasers and Their Applications’, Conf. on Advanced Solid State Photonics, ASSP, paper WE4, Vienna (2005);
Hudson et al., ‘Mode-locked fiber laser frequency-controlled with an intracavity electro-optic modulator’, OPTICS LETTERS, Vol. 30, pp. 2948-2950 (2005);
C. C. Lee, C. Mohr, J. Bethge, S. Suzuki, M. E. Fermann, I. Hartl, and T. R. Schibli, “Frequency comb stabilization with bandwidth beyond the limit of gain lifetime by an intracavity graphene electro-optic modulator”, OPTICS LETTERS, Vol. 37, pp. 3084-3086 (2012);
L. C. Sinclair, I. Coddington, W. C. Swann, G. B. Rieker, A. Hati, K. Iwakuni, and N. R. Newbury, “Operation of an optically coherent frequency comb outside the metrology lab,” Opt. Express, Vol. 22, pp. 6996-7006 (2014); and
W. Zhang, et al., “Advanced noise reduction techniques for ultra-low phase noise optical-to-microwave division with femtosecond fiber combs”, IEEE Trans UFFC 58, 900 (2011).

Accordingly, various aspects of the disclosure have been described herein.

Some of these aspects are summarized below.

In a first aspect, a frequency comb system comprises an Er soliton laser and a graphene modulator, said Er soliton laser characterized by having an absolute value of cavity dispersion>10,000 fs²/L, where L is the intra-cavity fiber length; and said graphene modulator is configured for carrier phase control.

In a second aspect, a frequency comb system comprises an Er soliton laser and a graphene modulator, said Er soliton laser characterized with an absolute value of cavity dispersion>10,000 fs²/L, where L is the intra-cavity fiber length; and said graphene modulator is configured for repetition rate control.

In a third aspect, a frequency comb system comprises an Er soliton laser and a graphene modulator, said Er soliton laser characterized with an absolute value of cavity dispersion>10,000 fs²/L, where L is the intra-cavity fiber length; and said graphene modulator is configured for amplitude noise control.

In a fourth aspect, a frequency comb system comprises an Er soliton laser and a graphene modulator, said Er soliton laser characterized with an absolute value of cavity dispersion<10,000 fs²/L, where L is the intra-cavity fiber length; and said graphene modulator is configured for carrier phase control.

In a fifth aspect, a frequency comb system comprises an Er soliton laser and a graphene modulator, said Er soliton laser characterized with an absolute value of cavity dispersion<10,000 fs²/L, where L is the intra-cavity fiber length; and said graphene modulator is configured for repetition rate control.

In a sixth aspect, a frequency comb system comprises an Er soliton laser and a graphene modulator, said Er soliton laser characterized with an absolute value of cavity dispersion<10,000 fs²/L, where L is the intra-cavity fiber length; and said graphene modulator is configured for amplitude noise control.

In a seventh aspect, a fiber frequency comb system is characterized by having a free-running carrier envelope offset frequency with a 3 dB linewidth Δf_{ceo}<1 MHz, said fiber frequency comb system further comprises an intra-cavity amplitude modulator, said intra-cavity amplitude modulator us configured for repetition rate control of said frequency comb system, wherein said amplitude modulator is configured to allow for a frequency modulation range Δfₒₚₜ of a comb line in the optical frequency domain, said frequency modulation range being achievable at least at one modulation frequency>20 kHz, wherein Δfₒₚₜ>Δf_{ceo}/100.

In an eighth aspect, the fiber frequency comb system according to aspect 7, further comprising a cw reference laser; said frequency comb system further configured to generate a beat signal f_{b} between said cw reference laser and at least one comb line of said frequency comb system; and said amplitude modulator configured for high precision phase locking of said comb line to said cw reference laser.

In a ninth aspect, the fiber frequency comb system according to aspect 8, said frequency comb system further comprising: a system to detect the carrier envelope offset frequency f_{ceo} of said fiber frequency comb system and mixing f_{b} with f_{ceo} to generate an RF signal with a frequency f₀=v_{cw}−n×fᵣ, where v_{cw} is the optical frequency of said reference laser, n is an integer and fᵣ is the repetition rate of said fiber frequency comb system.

In a tenth aspect, the fiber frequency comb system according to aspect 9, further comprising: a control system operatively connected to actuators and capable of providing modulation functions to lock f₀ to an external RF frequency reference via phase-locked loops and thereby generating a low phase noise RF signal of frequency f₀.

In an eleventh aspect, the fiber frequency comb system according to any one of aspects 8-10, wherein further comprising: an f-2f interferometer, a plurality of optical detectors, and a mixer.

In a twelfth aspect, the fiber frequency comb system according to any one of aspects 8-11, said cw reference laser being further locked to a high finesse optical cavity, a gas reference cell, or an optical atomic clock.

In a thirteenth aspect, the fiber frequency comb system according to any one of aspects 7-12, said amplitude modulator comprising a graphene modulator or an acousto-optic modulator.

In a fourteenth aspect, the fiber frequency comb system according to any one of aspects 7-13, said frequency comb system configured for low phase noise RF generation.

In an fifteenth aspect, the fiber frequency comb system according to any one of aspects 7-14, said fiber frequency comb system comprising one or a combination of Er, Yb, Nd, Tm, Ho or Pr doped fiber.

In a sixteenth aspect, the fiber frequency comb system according to any one of aspects 7-15, wherein Δfₒₚₜ>Δf_{ceo}/10.

In a seventeenth aspect, the fiber frequency comb system according to any one of aspects 7-16, wherein Δfₒₚₜ>Δf_{ceo}.

In an eighteenth aspect, a cavity enhanced optical spectroscopy system comprising a comb source; said comb source comprising a mode locked oscillator; a high bandwidth intra-cavity modulator for intra-cavity amplitude modulation of said comb source at a modulation frequency; an optical cavity, said optical cavity transmission comprising a spectrum which overlaps with the emission spectrum of said comb source in at least a first narrow spectral range; a detector configured to detect the light reflected from the cavity in said first narrow spectral range; a phase detector or mixer configured to create an error signal from the modulation frequency; and an electronic feedback loop responsive to said error signal and configured to lock the cavity mode resonances to the comb frequencies of said comb source.

In a nineteenth aspect, the cavity enhanced optical spectroscopy system according to aspect 18, said intra-cavity modulator comprising a graphene modulator.

In a twentieth aspect, the cavity enhanced optical spectroscopy system according to aspect 18 or aspect 19, said intra-cavity modulator configured for locking the repetition rate of said comb source to the cavity mode spacing.

In a twenty-first aspect, a cavity enhanced optical spectroscopy system comprising: a comb source, said comb source comprising a mode locked oscillator; a graphene modulator configured for repetition rate control of said comb source via an electronic feedback loop; and an optical cavity, said optical cavity transmission comprising a spectrum which overlaps with the emission spectrum of said comb source in at least a first narrow spectral range.

In a twenty-second aspect, the cavity enhanced optical spectroscopy system according to aspect 21, further comprising an acousto-optic or electro-optic modulator upstream of said optical cavity for control of the carrier envelope offset frequency of said comb source.

In a twenty-third aspect, the cavity enhanced optical spectroscopy system according to aspect 21 or aspect 22, further comprising at least one DFG, OPO or OPA stage for frequency shifting of the output spectrum of said comb source.

In a twenty-fourth aspect, a mid-IR fiber source based on DFG or OPA, comprising: a mode locked fiber oscillator; at least one fiber amplifier and a fiber supercontinuum stage; at least one pump diode configured to pump said fiber oscillator and fiber amplifier, said pump diode being driven by a current source; said fiber supercontinuum stage configured to produce tunable mid IR output via DFG or OPA between the fiber supercontinuum output and at least a fraction of the fiber amplifier output; and an amplitude noise reduction arrangement via a feedback loop to reduce the amplitude noise of the mid IR output; said amplitude noise reduction arrangement based on control of said oscillator or amplifier pump diode current.

In a twenty-fifth aspect, the mid IR fiber source according to aspect 24, said amplitude noise reduction arrangement comprising a graphene modulator inside said mode locked fiber oscillator.

In a twenty-sixth aspect, a frequency comb system comprising: a fiber oscillator having an intra-cavity graphene modulator and an intra-cavity bulk modulator, said frequency comb system configured for control of at least a carrier envelope offset frequency, f_{ceo}.

In a twenty-seventh aspect, the frequency comb system according to aspect 26, further comprising a waveguide modulator disposed downstream from said oscillator.

In a twenty-eighth aspect, the frequency comb system according to aspect 26 or 27, wherein said fiber oscillator is polarization maintaining.

In a twenty-ninth aspect, the frequency comb system according to any one of aspects 26-28, further comprising a supercontinuum generator and an f-2f interferometer disposed downstream from said fiber oscillator.

In a thirtieth aspect, the frequency comb system according to any one of aspects 26-29, said system providing a frequency comb exhibiting phase noise suppression of at least about 10 dB over a frequency range up to about 100 kHz.

In any or all aspects or embodiments, the comb lasers disclosed herein can be configured to exhibit phase noise suppression of at least about 10 dB over a frequency range up to about 100 kHz.

In any or all aspects or embodiments, the comb lasers disclosed herein can be configured such that Δfₒₚₜ>Δf_{ceo}/100, or Δfₒₚₜ>Δf_{ceo}/10, or Δfₒₚₜ>Δf_{ceo}.

In any or all aspects or embodiments, the comb lasers disclosed herein can comprise a graphene modulator. The graphene modulator can be configured to provide carrier phase control, repetition rate control, or amplitude noise control.

Thus, the invention has been described in several aspects and embodiments. It is to be understood that the aspects and embodiments are not mutually exclusive, and elements described in connection with one aspect or embodiment may be combined with, rearranged, or eliminated from, other aspects or embodiments in suitable ways to accomplish desired design objectives. No single feature or group of features is necessary or required for each aspect or embodiment.

For purposes of summarizing the present invention, certain aspects, advantages and novel features of the present inventions are described herein. It is to be understood, however, that not necessarily all such advantages may be achieved in accordance with any particular aspect or embodiment. Thus, the present inventions may be embodied or carried out in a manner that achieves one or more advantages without necessarily achieving other advantages as may be taught or suggested herein.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” or “an” or “the” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), or both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present.

Thus, while only certain embodiments have been specifically described herein, it will be apparent that numerous modifications may be made thereto without departing from the spirit and scope of the invention. Further, acronyms are used merely to enhance the readability of the specification and claims. It should be noted that these acronyms are not intended to lessen the generality of the terms used and they should not be construed to restrict the scope of the claims to the embodiments described therein.

What is claimed is:

1) A fiber frequency comb system having a free-running carrier envelope offset frequency with a 3 dB linewidth Δf_{ceo} less than 1 MHz, said fiber frequency comb system further comprising:
an intra-cavity amplitude modulator, said intra-cavity amplitude modulator configured for repetition rate control of said fiber frequency comb system, wherein said intra-cavity amplitude modulator is configured to allow for a frequency modulation range Δfₒₚₜ of a comb line in an optical frequency domain, said frequency modulation range being achievable at least at one modulation frequency greater than 20 kHz, wherein Δfₒₚₜ is greater than Δf_{ceo}/100.

2) A fiber frequency comb system according to claim 1, further comprising:
a continuous wave (cw) reference laser;
said fiber frequency comb system further configured to generate a beat signal f_{b} between said cw reference laser and at least one comb line of said fiber frequency comb system;
said intra-cavity amplitude modulator configured for high precision phase locking of said comb line to said cw reference laser.

3) A fiber frequency comb system according to claim 2, further comprising:
a system configured to detect the carrier envelope offset frequency f_{ceo} of said fiber frequency comb,
said system configured to mix the beat signal f_{b} with f_{ceo} to generate a radio frequency (RF) signal with a frequency f₀=V_{cw}−n×fᵣ, where v_{cw} is the optical frequency of said reference laser, n is an integer, and fᵣ is the repetition rate of said fiber frequency comb system.

4) A fiber frequency comb system according to claim 3, further comprising:
a control system operatively connected to actuators and configured to provide modulation functions to lock f₀ to an external RF frequency reference via at least one phase-locked loop, the control system thereby configured to generate a low phase noise RF signal of frequency f₀.

5) A fiber frequency comb system according to claim 2, further comprising:
an f-2f interferometer, a plurality of optical detectors, and a mixer.

6) A fiber frequency comb system according to claim 2, said cw reference laser configured to be further locked to a high finesse optical cavity, a gas reference cell, or an optical atomic clock.

7) A fiber frequency comb system according to claim 1, said intra-cavity amplitude modulator comprising a graphene modulator or an acousto-optic modulator.

8) A fiber frequency comb system according to claim 1, said fiber frequency comb system configured for low phase noise radio frequency (RF) generation.

9) A fiber frequency comb system according to claim 1, said fiber frequency comb system comprising one or a combination of Er, Yb, Nd, Tm, Ho or Pr doped fiber.

10) A fiber frequency comb system according to claim 1, wherein Δfₒₚₜ is greater than Δf_{ceo}/10.

11) A fiber frequency comb system according to claim 1, wherein Δfₒₚₜ is greater than Δf_{ceo}.

12) A mid-infrared (IR) fiber source based on difference frequency generation (DFG) or optical parametric amplification (OPA), the fiber source comprising:
a mode locked fiber oscillator;
a fiber amplifier;
a fiber supercontinuum stage;
a pump diode configured to pump said fiber oscillator and said fiber amplifier, said pump diode configured to be driven by a current source configured to provide a pump diode current to said fiber oscillator and to said fiber amplifier;
said fiber supercontinuum stage configured to produce tunable mid-IR output via DFG or OPA between output from the fiber supercontinuum stage and at least a fraction of output from the fiber amplifier; and
an amplitude noise reduction arrangement via a feedback loop to reduce amplitude noise of the tunable mid-IR output,
wherein said amplitude noise reduction arrangement is based on control of said pump diode current to said fiber oscillator or said pump diode current to said fiber amplifier.

13) A mid-IR fiber source according to claim 12, said amplitude noise reduction arrangement comprising a graphene modulator inside said mode locked fiber oscillator.

14) A frequency comb system comprising:
a fiber oscillator having an intra-cavity graphene modulator and an intra-cavity bulk modulator, said frequency comb system configured for control of at least a carrier envelope offset frequency, f_{ceo}.

15) A frequency comb system according to claim 14, further comprising a waveguide modulator disposed downstream from said fiber oscillator.

16) A frequency comb system according to claim 14, wherein said fiber oscillator is polarization maintaining.

17) A frequency comb system according to claim 14, further comprising a supercontinuum generator and an f-2f interferometer disposed downstream from said fiber oscillator.

18) A frequency comb system according to claim 14, said frequency comb system configured to provide a frequency comb exhibiting phase noise suppression of at least about 10 dB over a frequency range up to about 100 kHz.

19) A cavity enhanced optical spectroscopy system comprising:
a comb source comprising a mode locked oscillator;
a high bandwidth intra-cavity modulator for intra-cavity amplitude modulation of said comb source at a modulation frequency;
an optical cavity, wherein transmission from said optical cavity comprises a spectrum which overlaps with an emission spectrum of said comb source in at least a first narrow spectral range;
a detector configured to detect light reflected from the cavity in said first narrow spectral range;
a phase detector or mixer configured to create an error signal from the modulation frequency; and
an electronic feedback loop responsive to said error signal and configured to lock cavity mode resonances to comb frequencies of said comb source.

20) A cavity enhanced optical spectroscopy system comprising:
a comb source comprising a mode locked oscillator;
a graphene modulator configured for repetition rate control of said comb source via an electronic feedback loop; and
an optical cavity, wherein transmission from said optical cavity comprises a spectrum which overlaps with an emission spectrum of said comb source in at least a first narrow spectral range.
